(19) United States
(12) Patent Application Publication
(10) Pub. No.: US 2018/0185227 A1
(43) Pub. Date: Jul. 5, 2018

(54) DISPOSABLE BAG FOR THE COLLECTION OF URINE, VOMIT, AND OTHERS

(71) Applicant: Fernanda Coelho BRITES PINTO, Rio de Janeiro (BR)

(72) Inventor: Fernanda Coelho BRITES PINTO, Rio de Janeiro (BR)

(21) Appl. No.: 15/432,974

(22) Filed: Feb. 15, 2017

(30) Foreign Application Priority Data
Jan. 4, 2017 (BR) BR1020170001733

(51) Int. Cl. A61G 9/00; A47K 11/06; B65D 75/00; B65D 33/00

(52) U.S. Cl. CPC A61G 9/00; B65D 33/004; B65D 75/008; A47K 11/06

(57) ABSTRACT

Aimed to, but not exclusively, the use at hospitals and similar facilities. It features a body shaped by rectangular plates, anterior and posterior, made out of flexible plastic—or any similar material suited for this purpose—so its side edges are joined together by any process that suits the product forming side wings that extend through the whole longitudinal body of the bag. It also possesses as inferior seal with a plate of flexible plastic—or any similar material suited for this purpose—with substantially squared, round or elliptical shape, its peripheral edge is connected to the inferior edges of the anterior and posterior plates of the bag—through any process that suits the product—shaping inferior wings that go through the whole lower peripheral extension of the body of the bag, that alongside the side wings constitute the bag's proper structure. After the use the gelled content assumes a regular shape, significantly cylindrical, in a way that combined with a scale and the its capacity of standing stable in vertical position it becomes possible to perform a proper bodily fluid balance of the patient.

### FIELD OF THE INVENTION

Descriptive report of the patent of invention of a disposable bag to collect urine, vomit, and other regurgitated residue destined, preferably, for the use in hospitals, which can, after the first use, be kept stabled in vertical position to, with the help of a scale, provide an adequate bodily fluid balance for the patient.

### BACKGROUND OF THE TECHNIQUE

The document of Patent BRMU8401161-0 describes a urine collector composed of a curved element with a strap to provide support, and a transparent plastic bag which contains a volume meter, the plastic bag is fixed to the curved element through a high frequency weld to allow a perfect view of coloring, aspect, and volume of the urine collected; however, this kind of development, due to the impossibility of maintaining the plastic bag in vertical position, doesn't enable, in a precise way, the verification of the amount of urine disposed by the patient.

The document of Patent BRMU8401161-0 describes a disposable bag that transforms the regurgitated residues and others in gel, composed of a plastic bag with an anatomic nozzle on its extremity, made of flexible material, with a Velcro closing system, it includes, in its internal part, absorbent crystal gel, in an appropriate quantity compatible with the bag's capacity. This type of development, as the previous one, doesn't provide stability for the bag when it's placed in vertical position, and doesn't enable, in a precise way, the verification of the amount of urine disposed by the patient.

The document of Patent BRMU8401161-0 describes a urine collector for fluid balance, oxo-biodagradable and disposable with gelling action for the use at hospitals. It's composed by a plastic bag with a volume scale, a reinforced opening by the bend on its superior border, and an opening at one of the sides to the placement of a sachet made of a flexible material fixed in a provisional manner in the superior portion of the bag containing an amount of gel compatible with the bag's capacity; This type of development also doesn't provide stability for the bag when it's placed in the vertical position, and doesn't enable, in a precise way, the verification of the amount of urine disposed by the patient.

The document of patent BR102012032652-3 describes a bag for physiological emergencies, vomit and other regurgitations, obtained from a silicone paper strip, for example; a layer of Kraft paper or similar, coextruded to at least one sealant layer made of plastic film or polyester acrylic resin, such layer is applied in at least one of the faces of the sealant layer, preferably to the one that composes the internal surface of the contention bag, the silicone paper strip is cut in a manner to compose a structure formed by anterior and posterior walls, self-supporting basis and nozzle with broad opening, equipped or not with a sealant component, such as, a folding flab that includes a double-sided tape; the referred bag of contention incorporates a self-supporting basis presenting a transversal fold that juxtaposes two parts to the anterior and posterior walls, but while in use, the self-supporting basis extends itself keeping the parts juxtaposed to the anterior and posterior walls coplanar among themselves and angular in relation to the anterior and posterior walls; Although this kind of development possesses the possibility of keeping the plastic bag stable when in vertical position, it presents an inconvenient, the dimensions on its sides vary along its vertical extension, which doesn't enable, in a precise way, the verification of the amount of urine disposed by the patient.

The document of Patent US20120014623 is an already known bag with flat extremity made out of a material of flexible pellicle, composed of two parts of walls connected through longitudinal seams resulting in a tubular body, that includes, in its second application, a basis disposed significantly perpendicular to its longitudinal axis, which works as a resting surface with a resealable opening, present in at least one extremity of the said tubular body, in order to increase the rigidity of the tubular body the strips in the sealing edge are folded upon the bag's wall through an adhesive or a sealing compound, that can be applied directly to the pellicle material in predetermined spots before the bags manufacturing; Although the bag of this development is not destined to the collection of urine, vomit and others, it is possible to be stabilized in vertical position; However, its process of acquisition is proved to be complex and laborious, and also demands the application of adhesive or sealing compound to keep the stripes on the edge of sealing folded over the wall of the bag in order to shape the basis.

It's observed that the known bags from the current technique do not posses ways to provide adequate safety against content leaking, before or after use, besides not including the addition of an anatomic nozzle, fit for both genders, capable of preventing risks, to both the private parts and to the patients mouths, and that even allows the use in an ambulance along the way to a hospital and others.

It's noticed that the bags known on the current technique state do not offer proper conditions for the analysis of bodily fluid balance due to irregular shapes caused by the gelled content inside the bag.

Therefore, the proposition of a disposable bag for the collection of urine, vomit and others, becomes desirable; with simple and low cost production that provides comfort and safety for users while handling the product, that assures proper hermeticity after the use, and allows the gelled content inside the bag to adopt a shape that enables the verification of the volume of fluids expelled by the patient, so with the help of a scale, and its own capability of standing stable when in vertical position, it becomes possible to perform a proper bodily fluid balance of the patient.

### SUMMARY OF THE INVENTION

In order to overcome the disadvantages present in the current techniques, it's proposed a disposable bag for the collection of urine, vomit, and other regurgitated residues. It aims to be used in hospitals, but not exclusively. It's shaped in a body structured with plates, anterior and posterior, made of flexible plastic—or any similar material suited for this purpose—the referred plates are significantly rectangular with side edges joined together through any process that suits the product, so they form side wings that extend through the whole longitudinal body of the bag. It also possesses a lower seal made of a plate of flexible plastic—or any similar material suited for this purpose—with substantially squared, round or elliptical shape, its peripheral edge is connected to the lower edges of the anterior and posterior plates in the body of the bag—through any process that suits the product—shaping lower wings that go through the whole lower peripheral extension of the body of the bag, that in cooperation with the side wings constitute the bag's proper structure. After the use the gelled content assumes a regular shape, significantly cylindrical, in a way that combined with a scale and its capability of standing stable in vertical position it becomes possible to perform a proper bodily fluid balance of the patient.

The proposed disposable bag for the collection of urine, vomit and others can be used by men and women, regardless of age; In order to offer a more favorable autonomy to the female gender, its flexible nozzle—obtained in Ethylene-vinyl acetate (EVA) or any material suited for its purpose—is anatomic and constituted of one of the extremities longer than the other, which can also be offered in versions with different colors and/or fragrances.

The proposed disposable bag for the collection of urine, vomit and others includes a closing system to its upper opening through a seal, of ziplock type, located through the transversal extension of the bag, which can be opened and closed as many times as necessary, it refrains humidity infiltration or the access to the crystals, before and after the use, as well as the leaking of the contents.

The proposed disposable bag for the collection of urine, vomit and others can also be manufactured in materials that allow recycling, composting, degradation and other, without affecting the environment.

This invention's main objective is of a product that offers an easier handling and an increase on its features, providing higher asepsis, safety, comfort, and convenience to both users and health professional by minimizing the spreading of infectious diseases as well as odor.

The proposed disposable bag for the collection of urine, vomit and others can be manufactured in different sizes and volume.

The proposed disposable bag for the collection of urine, vomit and others can be used as personal emergency item, as a provision for the lack of bathrooms available.

### BRIEF DESCRIPTION OF THE DRAWINGS

As way to widen the comprehension of the disposable bag for the collection of urine, vomit and other, the attached drawings work as a reference, so it can be fully reproduced by appropriate techniques, providing a complete description of its features; however, the referred drawings are merely explanatory as they can vary as long as they maintain the proposed principle. So:

FIG. 1 illustrates an upper perspective view on the package that contains one unit of the proposed bag.

FIG. 2 illustrates a perspective view of the disposable bag, extracted from the unitary package, folded.

FIG. 3 illustrates a perspective view of the disposable bag being unfolded before use.

FIG. 4 illustrates a frontal perspective view of the disposable bag ready for use.

FIG. 5 illustrates a perspective view of the back of the disposable bag ready for use.

FIG. 6 illustrates a perspective view of the face of the disposable bag after use.

FIG. 7 illustrates a perspective view of the back part of the disposable bag, after use, stable in vertical position.

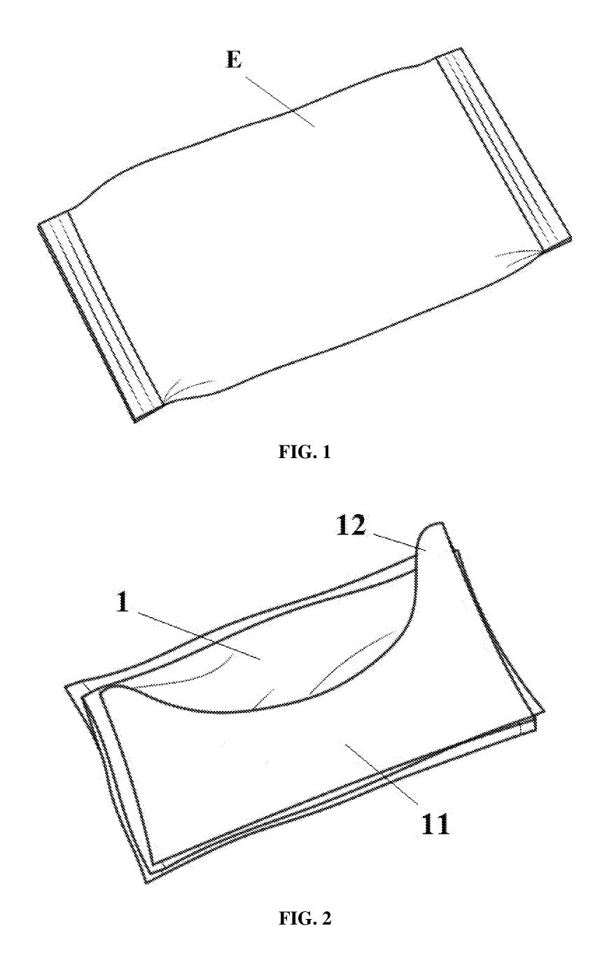

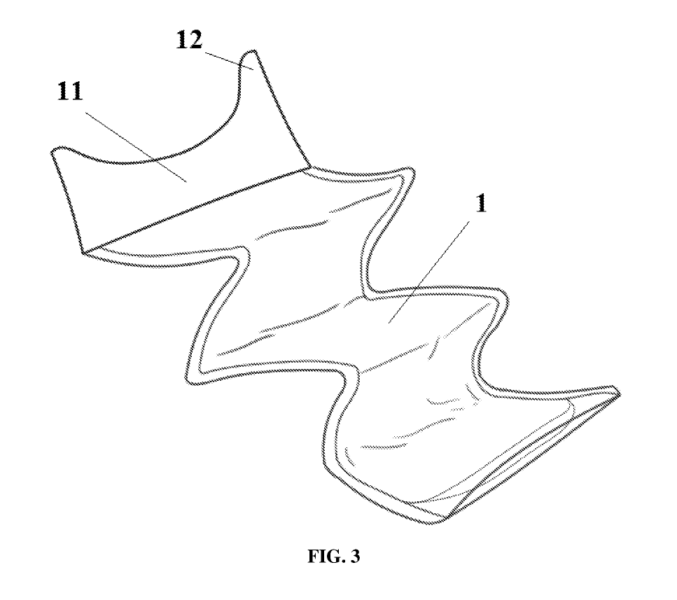

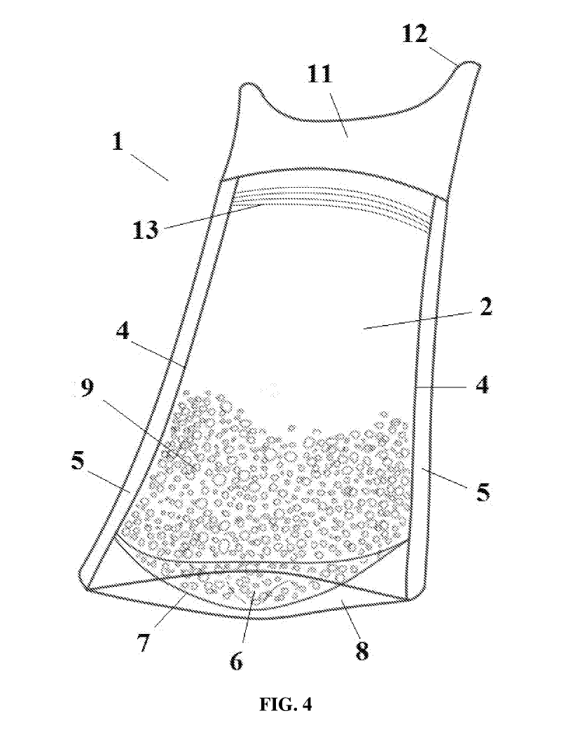

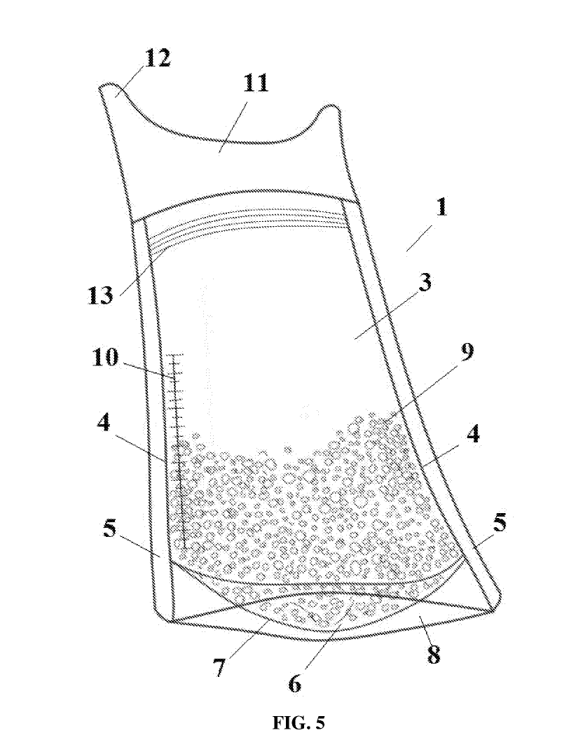

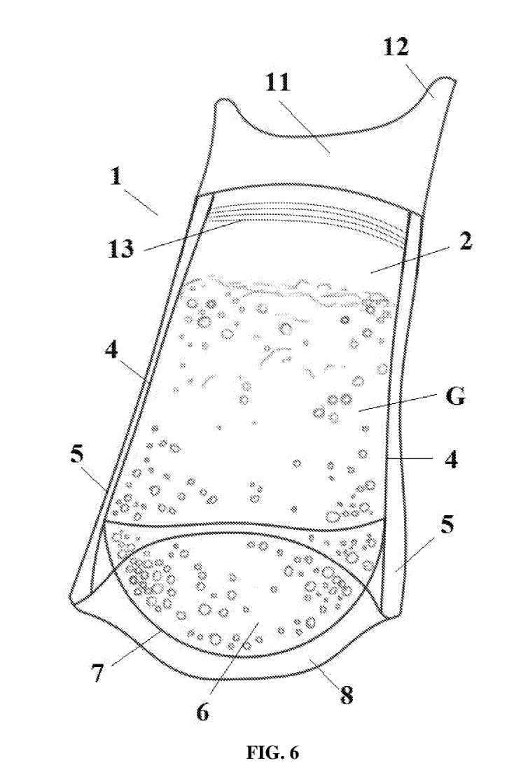

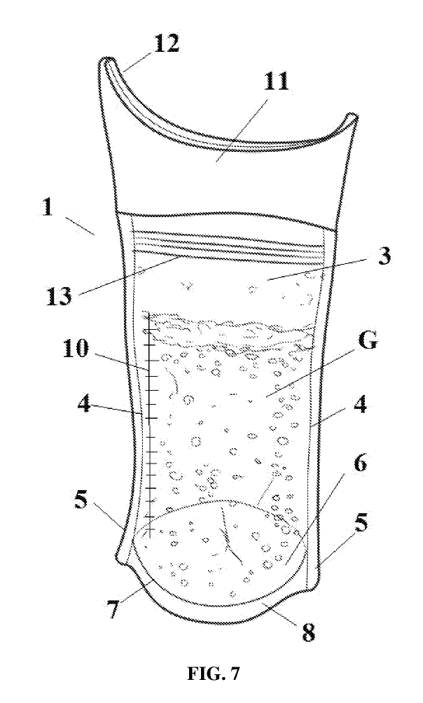

### DESCRIPTION OF THE INVENTION

In conformity with the illustrated drawings attached, the proposed disposable bag for the collection of urine, vomit, and others is supplied in an individual package (E), being the body (1) of the bag composed by plates, frontal (2) and rear (3), of flexible plastic—or any other suited material for its purpose—that are significantly rectangular with its side wings (4) joined together—through any appropriate process—making side wings (5) that go through the whole longitudinal extension of the bag. And also a lower seal composed of a basis plate (6) of flexible plastic—or any other material suited for its purpose—that is significantly squared, round or elliptical with its peripheral edge (7) joined to the lower edges of the frontal and rear plates of the body of the bag—by any process appropriated—creating lower wings (8) that go through the whole lower peripheral extension of the bag mentioned; that cooperating with the side wings builds a proper structure for the bag, which due to the action of the crystal gel (9), the gelled content (G) assumes a regular and significantly cylindrical shape after the use. So with the assistance of a scale (10) the bag becomes able to be kept stable in vertical position and it's possible to perform a proper bodily hydric balance of the patient.

The proposed disposable bag for the collection of urine, vomit, and others, can have the scale placed in its front or back side.

The proposed disposable bag for the collection of urine, vomit, and others can be used by both men and women, and as a sense to offer a more favorable anatomy to the female gender, its flexible nozzle (11), obtained in rubberized materials such as Ethylene-vinyl acetate (EVA)—or any material suited for its purpose—is constituted by one of the extremities (12) longer than the other, which can also be offered in version with different colors and/or fragrances.

The proposed disposable bag for the collection of urine, vomit, and others, also features a closing system of its superior opening through a seal (13) of ziplock type, placed through the transversal extension of the bag, which can be opened and closed as many times as necessary, it refrains humidity infiltration or the access to the crystals, before and after the use, as well as its contents' leaking.

The proposed disposable bag for the collection of urine, vomit, and others can also be manufactured with materials that allow recycling, composting, degradation and others, without affecting the environment.

The proposed disposable bag for the collection of urine, vomit, and others main objective is of a product that offers an easier handling and an increase on its features, providing higher asepsis, safety, comfort, and convenience to both users and health professional, and can also be used in situations such as in an ambulance on the way to the hospital.

The proposed disposable bag for the collection of urine, vomit, and others, minimize the spreading of infectious diseases as well as odor.

The proposed disposable bag for the collection of urine, vomit, and others can be produced in different sizes and volume.

The proposed disposable bag for the collection of urine, vomit, and others can be used as personal emergency item, as a provision for the lack of bathrooms available.

1. A disposable bag for collection of body fluids including urine, vomit, and others comprising:
an individual sealed package including:
a flexible and anatomic nozzle;
a body (1) having a first end connected to the flexible and anatomic nozzle a second end, a front plate (2), and a back plate (3), the body is made of a flexible material, the front plate and the plate have a rectangular shape, the front plate and the back plate including side edges (4) that are joined together forming side wings (5), the side wings extend longitudinally along the body;
a lower seal located on the second end of the body, the lower seal having a basis plate (6) made of a flexible material and a peripheral edge (7), the basis plate is located between a bottom edge of the front plate and a bottom edge of the back plate;
bottom wings are protruding from the peripheral edge (7) of the lower seal;
a measurement scale located on the front or the back plate;
a gel material (9) located inside the body;
wherein when the body is filled with the body fluids, the gel material expands separating the front plate from the back plate, the basis plate unfolds defining a floor for the disposable bag and the side wings stand producing a self-standing disposable bag.

2. The disposable bag according to claim 1, wherein the basis plate (6) has squared, round or elliptical shape.

3. The disposable bag according to claim 1, in a working position, the gel material (9) expands and assumes a cylindrical shape.

4. (canceled)

5. (canceled)

6. The disposable bag according to claim 1, wherein the flexible nozzle (11) is made of a rubberized materials and includes a first extremity (12) that is longer than a second extremity.

7. The disposable bag according to claim 1, further including a closing system located on a superior opening on the body, the closing system including a seal (13) placed transversally through an extension of the bag.

8. The disposable bag according to claim 1, wherein the disposable bag is designed to be used in a moving vehicle.

9. The disposable bag according to claim 1, wherein the disposable bag is manufactured in different sizes and volumes.

10. (canceled)

11. A disposable bag for collection of urine, vomit, and others, consisting of:
an individual sealed package consisting of:
a flexible and anatomic nozzle;
a body (1) having a first end connected to the flexible and anatomic nozzle, a second end, a front plate (2), and a back plate (3), the body is made of a flexible material, the front plate and the plate have a rectangular shape, the front plate and the back plate including side edges (4) that are joined together forming side wings (5), the side wings extend longitudinally along the body;
a lower seal located on the second end of the body, the lower seal having a basis plate (6) made of a flexible material and a peripheral edge (7), the basis plate is located between a bottom edge of the front plate and a bottom edge of the back plate;
bottom wings are protruding from the peripheral edge (7) of the lower seal;
a measurement scale located on the front or the back plate;
a gel material (9) located inside the body;
wherein when the body is filled with the body fluids, the gel material expands separating the front plate from the back plate, the basis plate unfolds defining a floor for the disposable bag and the side wings stand producing a self-standing disposable bag.
